(19) United States
(12) Patent Application Publication
(10) Pub. No.: US 2018/0105122 A1
(43) Pub. Date: Apr. 19, 2018

(54) METHOD FOR PRODUCING AN ACOUSTIC PROTECTION SCREEN FOR A MOTOR VEHICLE ENGINE AND SCREEN OBTAINED USING SUCH A METHOD

(71) Applicant: CERA APS, Reims (FR)

(72) Inventor: Laurent WAXIN, Dravegny (FR)

(21) Appl. No.: 15/559,470

(22) PCT Filed: Feb. 25, 2016
(86) PCT No.: PCT/FR2016/050439

§ 371 Date: Sep. 19, 2017

(30) Foreign Application Priority Data
Mar. 20, 2015 (FR) 1552315

(51) Int. Cl. B60R 13/08; G10K 11/168; B29C 43/00; B29C 69/02; B32B 3/26; B32B 15/08; B32B 15/04; B32B 15/095; B32B 15/20

(52) U.S. Cl. CPC B60R 13/0838; G10K 11/168; B29C 43/003; B29C 69/02; B32B 3/266; B32B 15/08; B29C 43/18; B32B 15/095; B32B 15/20; B60Y 2410/12; B60Y 2306/09; B60Y 2410/114; B32B 15/046

(57) ABSTRACT

A method for producing an acoustic protection screen for a motor vehicle engine, comprising providing a reflective metal thermal protection sheet having a plurality of micro perforations, providing a batt of fibres containing a thermosetting resin, superposing the metal thermal protection sheet and the batt in a first thermocompression mould, compressing the batt by binding the fibres together, in order to form a thermal insulation layer, and combining the metal thermal protection sheet with the layer using the thermosetting resin, placing the thermal protection shell against an upper wall of a second mould, the wall being provided with out-gassing vents, the sheet facing toward the wall, injecting into the second mould an air-porous polyurethane foam precursor mixture, the lower wall of the second mould being free of any fluid-tight coating, after the foam has expanded, demoulding the screen obtained, in which screen the foam forms a support overmoulding the layer.

### BACKGROUND

The invention relates to a method for producing an acoustic protection screen for a motor vehicle engine and a screen obtained using such a method.

It is known to implement a method for producing an acoustic protection screen for a motor vehicle engine, said method comprising the following steps:
providing a reflective metal thermal protection sheet,
providing a batt of fibres containing a thermosetting resin,
superposing said sheet and said batt in a first thermocompression mould, in such a way as to compress said batt by binding said fibres together, in order to form a thermal insulation layer, and so as to combine said sheet with said layer using said resin, so as to obtain a thermal protection shell comprising said layer and said sheet,
placing said shell against the upper wall of a second mould, said sheet facing toward said wall,
injecting into said second mould an air-porous polyurethane foam precursor mixture, the lower wall of said second mould being free of any fluid-tight coating,
after the foam has expanded, demoulding the screen obtained, in which screen the foam forms a support overmoulding said layer.

The presence of such a thermal protection sheet is imposed when the support does not have sufficient resistance to the heat given off by the engine.

As for inserting an insulation layer between the metal sheet and the support, it is required when said sheet does not sufficiently reflect the heat emitted by the engine to provide the expected thermal protection, which could lead to a degradation of the support.

The transmission of the heat from the sheet to the support is then attenuated by the insulation layer, which makes it possible to satisfactorily provide the thermal protection of said support.

Moreover, the fact that the lower wall of the second mould is free of any fluid-tight coating allows the support to fully play its role of acoustic absorption, its outer face being fully able to receive, on the side opposite that of the engine, the noise coming from said engine in order to absorb it.

Note finally that the method described hereinabove allows for a robust anchoring between the insulation layer and the support, this due to a partial penetration of the foam of said support in said layer, said foam coating the surface fibres of said layer.

However, with the method disclosed hereinabove, a screen is obtained of which the outer face of the support made from foam—i.e. the face opposite the one receiving the insulation layer—can have defects, such as craters, detrimental to the appearance of the screen.

Such a disadvantage is caused by a poor evacuation of the gases coming from the reaction of the formation of the foam, said gases not able to be evacuated, due to the barrier formed by the metal sheet, via the top of the second mould.

### SUMMARY

The invention has an arrangement that makes it possible to overcome this disadvantage.

To this effect, and according to a first aspect, the invention proposes a method for producing an acoustic protection screen for a motor vehicle engine, said method comprising the following steps:
providing a reflective metal thermal protection sheet, said sheet being provided with a plurality of micro perforations,
providing a batt of fibres containing a thermosetting resin,
superposing said sheet and said batt in a first thermocompression mould, in such a way as to compress said batt by binding said fibres together, in order to form a thermal insulation layer, and so as to combine said sheet with said layer using said resin, so as to obtain a thermal protection shell comprising said layer and said sheet,
placing said shell against the upper wall of a second mould, said wall being provided with out-gassing vents, said sheet facing toward said wall,
injecting into said second mould an air-porous polyurethane foam precursor mixture, the lower wall of said second mould being free of any fluid-tight coating,
after the foam has expanded, demoulding the screen obtained, in which screen the foam forms a support overmoulding said layer.

It is specified here that the term “engine” must be considered in the broad sense, comprising among others the exhaust line of the vehicle, and more generally any portion of the vehicle that emits heat in a substantial amount, in particular at a minimum temperature of 200° C.

With the arrangement proposed, a screen is obtained of which the outer face of the support made of foam has a very satisfactory appearance, in particular free from craters or other surface defects, this due to the fact that the gases coming from the reaction of the formation of the foam are evacuated by the micro-perforations of the metal sheet.

Furthermore, the presence of such micro-perforations allows the sound waves to pass through the metal sheet on the side of the engine in order to be absorbed by the insulation layer and by the support.

According to a second aspect, the invention proposes a screen obtained by such a method.

### BRIEF DESCRIPTION OF THE DRAWINGS

Other particularities and advantages of the invention shall appear in the following description, given in reference to the attached figures, wherein:

FIG. 1 is a partial cross-section diagrammatical view if a screen in the process of manufacture, according to an embodiment, before the demoulding thereof,

FIG. 2 is a partial cross-section diagrammatical view of a screen according to a particular embodiment.

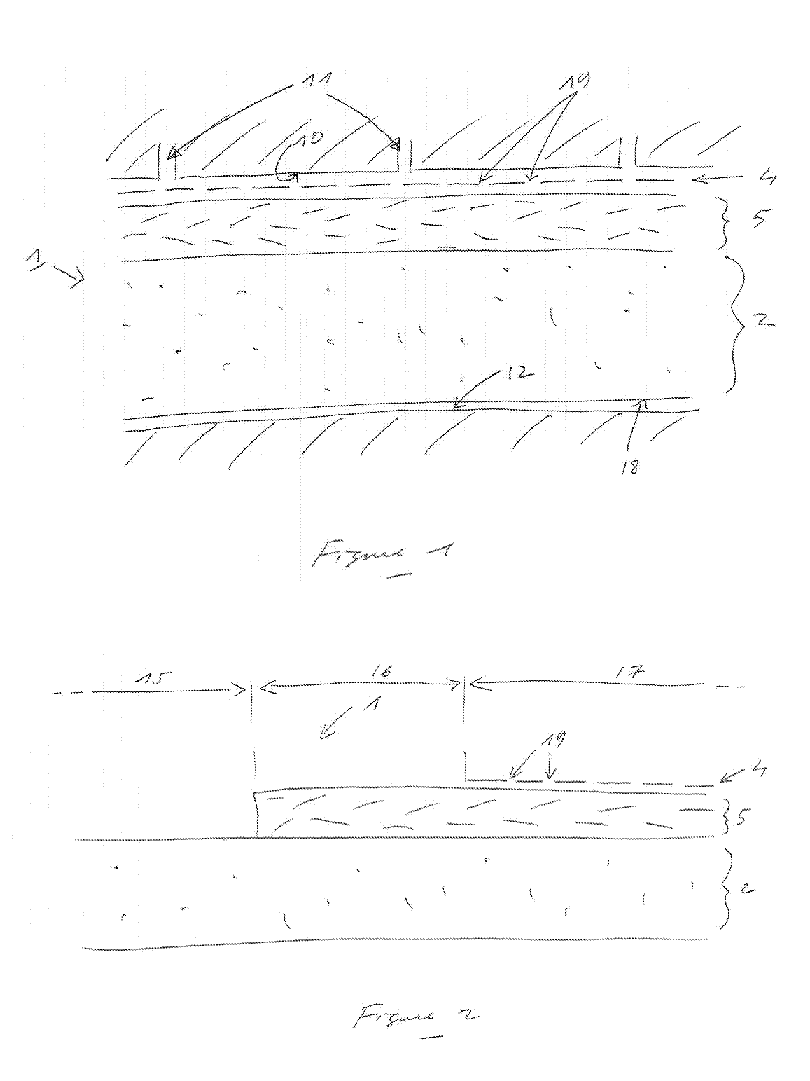

### DETAILED DESCRIPTION

In reference to the figures, a method for producing an acoustic protection screen 1 for a motor vehicle engine is described, said method comprising the following steps:
providing a reflective metal sheet 4—in particular made of aluminium—for thermal protection, said sheet being provided with a plurality of micro perforations 19,
providing a batt of fibres containing a thermosetting resin, in particular phenolic,
superposing said sheet and said batt in a first thermocompression mould, in such a way as to compress said batt by binding said fibres together, in order to form a thermal insulation layer 5, and so as to combine said sheet with said layer using said resin, so as to obtain a thermal protection shell comprising said layer and said sheet,
placing said shell against the upper wall 10 of a second mould, said wall being provided with out-gassing vents 11, said sheet facing toward said wall,
injecting into said second mould an air-porous polyurethane foam precursor mixture, the lower wall 12 of said second mould being free of any fluid-tight coating,
after the foam has expanded, unmoulding the screen 1 obtained, wherein the foam forms a support 2 overmoulding said layer.

According to an embodiment, the surface density of the micro-perforations 19 is between 400,000 and 600,000 micro-perforations per m².

An acoustic protection screen 1 for a motor vehicle engine obtained using such a method is now described, said screen comprising, arranged successively one on the other:
a reflective metal sheet 4—in particular made of aluminium—for thermal protection, said sheet being provided with a plurality of micro perforations 19, the surface density of the micro-perforations being in particular between 400,000 and 600,000 micro-perforations per m²,
a thermal insulation layer 5 of fibres bonded together by a thermosetting binder,
a support 2 with a porous polyurethane foam base that allows for the acoustic absorption of the noise coming from said engine, said support overmoulding said layer in such a way that the foam coats the surface fibres of said layer, the outer face 18 of said support—i.e. the face opposite the one receiving said layer—being free of any fluid-tight coating in such a way that said foam can absorb the noise coming from said engine.

It is specified here that the coating of the surface fibres of the insulation layer 5 by the foam is the consequence of the method such as implemented, wherein the foam precursor mixture coats said fibres during the expansion of the foam.

The foam once polymerised thus provides the coating observed for the surface fibres described hereinabove.

According to an embodiment not shown, the outer face 18 of the support 2 can be coated with a porous coating layer, for example of the non-woven type, said porous layer not obstructing the penetration of the sound waves within the foam of said support in order to be absorbed therein.

According to an embodiment, the support 2 has a resistance to the passing of air between 1000 and 1500 N·s·m⁻³, which allows it to correctly absorb the sound waves coming from the engine.

The fibres used are in particular mineral fibres—for example glass, silica or rock—chosen according to the expected characteristics of thermal conductivity.

According to an embodiment, the foam of the support 2 has a density between 0.22 and 0.28, and in particular between 0.23 and 0.27.

According to an embodiment, the insulation layer 5 has a thermal conductivity between 0.055 and 0.061 W·m⁻¹·K⁻¹ at 200° C., and in particular between 0.057 and 0.059 W·m⁻¹·K⁻¹.

According to an embodiment, the insulation layer 5 has a resistance to the passing of air less than 4000 N·s·m⁻³.

According to an embodiment, the insulation layer 5 has a thickness between 3 and 8 mm.

According to an embodiment, the insulation layer 5 has a surface density between 600 and 1000 g/m².

According to an embodiment, the fibres of the insulation layer 5 are bonded together by a phenolic resin.

According to an embodiment, the metal sheet 4 has a thickness between 50 and 150 microns, and in particular between 70 and 100 microns, an equally low thickness that contributes to lightening the screen 1.

According to the particular embodiment shown in FIG. 2, the insulation layer 5 partially covers the support 2.

According to an alternative not shown, the insulation layer 5 could cover the entire support 2.

According to this same embodiment, the sheet 4 partially covers the insulation layer 5.

It is as such possible to arrange a screen 1 of which a first portion 15 of the support 2 is free of any thermal protection and/or—here and, in the embodiment shown—a second portion 16 of said support is protected only by the insulation layer 5, a third portion 17 of said support, intended to be the most exposed, being protected by said insulation layer and by the metal sheet 4.

1. A method for producing an acoustic protection screen for a motor vehicle engine, said method comprising the steps:
providing a reflective metal thermal protection sheet, said metal thermal protection sheet being provided with a plurality of micro perforations,
providing a batt of fibres containing a thermosetting resin,
superposing said metal thermal protection sheet and said batt in a first thermocompression mould, compressing said batt by binding said fibres together, in order to form a thermal insulation layer, and combining said metal thermal protection sheet with said layer using said thermosetting resin, obtaining a thermal protection shell comprising said thermal insulation layer and said metal thermal protection sheet,
placing said thermal protection shell against an upper wall of a second mould, said wall being provided with out-gassing vents, said sheet facing toward said wall,
injecting into said second mould an air-porous polyurethane foam precursor mixture, the lower wall of said second mould being free of any fluid-tight coating,
after the foam has expanded, demoulding the screen obtained, in which screen the foam forms a support overmoulding said layer.

2. The method according to claim 1, wherein the surface density of the micro-perforations is between 400,000 and 600,000 micro-perforations per m².

3. An acoustic protection screen for a motor vehicle engine obtained by a method according to claim 1, said screen comprising, arranged successively one on the other:
a reflective metal sheet made of aluminium for thermal protection, said reflective metal sheet being provided with a plurality of micro perforations, the surface density of the micro-perforations being between 400,000 and 600,000 micro-perforations per m²,
a thermal insulation layer bonded together by a thermosetting binder,
a support with a porous polyurethane foam base allowing for the acoustic absorption of the noise coming from said engine, said support overmoulding said layer in such a way that the foam coats the surface fibres of said layer, the outer face of said support being free of any fluid-tight coating in such a way that said foam can absorb the noise coming from said engine.

4. The screen according to claim 3, wherein the support has a resistance to the passing of air of between 1000 and 1500 N·s·m⁻³.

5. The screen according to claim 4, wherein the foam of the support has a density of between 0.22 and 0.28, and in particular between 0.23 and 0.27.

6. The screen according to claim 5, wherein the insulation layer has a thermal conductivity of between 0.055 and 0.061 W·m⁻¹·K⁻¹ at 200° C., and in particular of between 0.057 and 0.059 W·m⁻¹·K⁻¹.

7. The screen according to claim 6, wherein the insulation layer has a resistance to the passing of air less than 4000 N·s·m⁻³.

8. The screen according to claim 7, wherein the insulation layer has a thickness of between 3 and 8 mm.

9. The screen according to claim 8, wherein the insulation layer has a surface density of between 600 and 1000 g/m².

10. The screen according to claim 9, wherein a first portion of the support is free of any thermal protection and/or a second portion of said support is protected only by the insulation layer, a third portion of said support, intended to be the most exposed, being protected by said insulation layer and by the metal sheet.
